(19) United States
(12) Patent Application Publication
(10) Pub. No.: US 2019/0195905 A1
(43) Pub. Date: Jun. 27, 2019

(54) DISPENSING METHOD

(71) Applicants: KAWASAKI JUKOGYO KABUSHIKI KAISHA, Kobe-shi (JP); SYSMEX CORPORATION, Kobe-shi (JP); MEDICAROID CORPORATION, Kobe-shi (JP)

(72) Inventors: Yukio IWASAKI, Kobe-shi (JP); Satoshi OUCHI, Kobe-shi (JP); Eiji MITSUI, Kobe-shi (JP); Junichi MATSUOKA, Kobe-shi (JP); Takehiro HASEGAWA, Kobe-shi (JP); Yukihiko KITANO, Kobe-shi (JP)

(73) Assignees: KAWASAKI JUKOGYO KABUSHIKI KAISHA, Kobe-shi (JP); SYSMEX CORPORATION, Kobe-shi (JP); MEDICAROID CORPORATION, Kobe-shi (JP)

(21) Appl. No.: 16/232,104

(22) Filed: Dec. 26, 2018

(30) Foreign Application Priority Data
Dec. 26, 2017 (JP) 2017-250234

(51) Int. Cl. G01N 35/10; G01N 35/00; B01L 3/02

(52) U.S. Cl. CPC G01N 35/1002; B01L 3/0275; B01L 3/021; G01N 35/0099

(57) ABSTRACT

A dispensing method executed in a robot system including a pipette, a tip, a container, a liquid in the container, and a robot including a robot arm, an end effector, and a robot controller that controls the robot arm and the end effector to perform operations on the pipette and the tip, includes: making the end effector hold the pipette and the tip attached to the pipette; dipping at least a point of the tip attached to the pipette in the liquid and aspirating the liquid into the tip; bringing an outer surface of the tip attached to the pipette into contact with a part of the container, wherein the part of the container is at least one of an edge of an opening and an inside surface; and pulling the pipette and the tip attached to the pipette out of the container through the opening.

### CROSS REFERENCE TO RELATED APPLICATIONS

This application claims priority based on 35 USC 119 from prior Japanese Patent Application No. 2017-250234 filed on Dec. 26, 2017, entitled “DISPENSING METHOD”, the entire contents of which are incorporated herein by reference.

### BACKGROUND

The disclosure relates to a dispensing method, more particularly to a dispensing method executed in a robot system.

There has heretofore been known a dispensing method executed in a robot system. Such a dispensing method is proposed, for example, in a dispensing system disclosed in Japanese Patent Application Publication No. 2016-212077 (Patent Literature 1).

The dispensing system disclosed in Patent Literature 1 includes: a robot that moves a dispenser to aspirate a dispensing target liquid; a camera that captures an image containing a tip portion of the dispenser, the liquid surface of the liquid, and a non-dispensing target positioned below the liquid surface; an image processor that acquires positional information on the liquid surface, positional information on a boundary between the liquid and the non-dispensing target, and positional information on the tip portion of the dispenser, based on the image; and a descent controller that controls the robot to lower the dispenser based on the three pieces of positional information for aspiration of the liquid into the dispenser.

Incidentally, in the dispensing method disclosed in Patent Literature 1 executed in the robot system and other dispensing methods according to a related art executed in a robot system, a liquid L adheres to the outer surface of a tip 3 after the liquid L is aspirated into the tip 3, as illustrated in FIGS. 7A to 7C. This could make it difficult to accurately dispense a desired amount of liquid. Here, Patent Literature 1 proposes that the dispenser is lowered based on the positional relationship between the liquid surface and the distal end portion of the dispenser (point portion of a tip), determined from the image, thereby keeping the distal end portion of the dispenser at a shallow position from the liquid surface, and thus the amount of the liquid adhering to the tip portion of the dispenser is reduced. However, the dispensing system disclosed in Patent Literature 1 needs the camera or the like to capture the image, leading to a problem that the device configuration of the robot system becomes complicated.

In view of such a problem, one or more embodiments may provide a dispensing method which is executed in a robot system with a simple device configuration and also enables accurate dispensing of a desired amount of liquid.

### SUMMARY

A method according to one or more aspects may be a dispensing method executed in a robot system, wherein the robot system includes: a pipette; a tip attached to the pipette; a container including a bottom surface, an inside surface, and an opening; a liquid contained in the container; and a robot including a robot arm, an end effector attached to a leading end of the robot arm, and a robot controller that performs operations on the pipette and the tip by controlling the robot arm and the end effector. The method may include: making the end effector hold the pipette and the tip attached to the pipette; dipping at least a point of the tip attached to the pipette in the liquid and aspirating the liquid into the tip; bringing an outer surface of the tip attached to the pipette into contact with a part of the container, wherein the part of the container is at least one of an edge of the opening and the inside surface; and pulling the pipette and the tip attached to the pipette out of the container through the opening.

A method according to one or more aspects may be a dispensing method to be executed in a robot system. The method may include: attaching a tip to a held pipette; moving the pipette so as to dip the tip in a liquid contained in a container, and aspirating the liquid into the tip; moving the pipette so as to bring the tip holding the aspirated liquid into contact with the container, thereby removing the liquid adhering to a side surface of the tip; and moving the pipette after bringing the tip into contact with the container, and discharging the liquid from the tip.

### BRIEF Description of Drawings

FIG. 1 is a diagram illustrating a schematic view of an overall configuration of a robot system in which a dispensing method according to one or more embodiments is executed;

FIG. 2 is a diagram illustrating an external perspective view of an 8-channel pipette and tips attached thereto used in a dispensing method according to one or more embodiments;

FIG. 3A is a diagram illustrating a schematic view of a first step of a dispensing method according to one or more embodiments, and FIG. 3B is a diagram illustrating a schematic view of a second step of a dispensing method according to one or more embodiments;

FIG. 4A is a diagram illustrating a schematic view of a third step of a dispensing method according to one or more embodiments, and FIG. 4B is a diagram illustrating a schematic view of a fourth step of a dispensing method according to one or more embodiments;

FIG. 5A is a diagram illustrating a schematic view of a third step of a dispensing method according to a first modification, and FIG. 5B is a diagram illustrating a schematic view of a fourth step of a dispensing method according to a first modification;

FIG. 6A is a diagram illustrating a schematic view of a third step of a dispensing method according to a second modification, and FIG. 6B is a diagram illustrating a schematic view of a fourth step of a dispensing method according to a second modification; and

FIGS. 7A to 7C are diagrams illustrating schematic views of how a liquid is aspirated into a tip in a related art dispensing method executed in a robot system.

### DETAILED DESCRIPTION

A dispensing method according to a first aspect is a dispensing method executed in a robot system, wherein the robot system includes: a pipette; a tip attached to the pipette; a container including a bottom surface, an inside surface, and an opening; a liquid contained in the container; and a robot including a robot arm, an end effector attached to a leading end of the robot arm, and a robot controller that controls the robot arm and the end effector to perform operations on the pipette and the tip, the method including: making the end effector hold the pipette and the tip attached to the pipette; dipping at least a point of the tip attached to the pipette in the liquid and aspirating the liquid into the tip; bringing an outer surface of the tip attached to the pipette into contact with a part of the container, wherein the part of the container is at least one of an edge of the opening and the inside surface; and pulling the pipette and the tip attached to the pipette out of the container through the opening.

According to the above configuration, the liquid adhering to the outer surface of the tip can be wiped off by pulling the pipette and the tip attached thereto out of the container through the opening after bringing the outer surface of the tip attached to the pipette into contact with a part of the container, which is at least one of the edge of the opening and the inside surface. As a result, the dispensing method according to a first aspect is executed in the robot system with a simple device configuration and also enables accurate dispensing of a desired amount of liquid.

The pulling the pipette and the tip attached to the pipette out of the container through the opening may include pulling the pipette and the tip attached to the pipette out of the container through the opening while sliding the outer surface of at least the point of the tip attached to the pipette against the part of the container.

According to the above configuration, the liquid adhering to the outer surface of the tip can be surely wiped off.

For example, the opening may be formed across an entire top surface of the container, and a part of the container may be a curved portion positioned at an upper end of the inside surface or in a vicinity of the upper end of the inside surface.

For example, the opening may be formed across an entire top surface of the container, and a part of the container may be a portion of the inside surface, the portion extending in a height direction of the inside surface.

The dipping at least the point of the tip attached to the pipette in the liquid and aspirating the liquid into the tip may include dipping at least the point of the tip attached to the pipette in the liquid by bringing the point of the tip attached to the pipette into contact with or close to the bottom surface of the container.

According to the above configuration, at least the point of the tip attached to the pipette can be surely dipped in the liquid regardless of the height position of the liquid surface.

A dispensing method according to a second aspect is a dispensing method to be executed in a robot system, including: attaching a tip to a held pipette; moving the pipette so as to dip the tip in a liquid contained in a container, and aspirating the liquid into the tip; moving the pipette so as to bring the tip holding the aspirated liquid into contact with the container, thereby removing the liquid adhering to a side surface of the tip; and moving the pipette after bringing the tip into contact with the container, and discharging the liquid from the tip.

The dispensing method according to a second aspect is executed in the robot system with a simple device configuration and also enables accurate dispensing of a desired amount of liquid.

Embodiments are explained with referring to drawings. In the respective drawings referenced herein, the same constituents are designated by the same reference numerals and duplicate explanation concerning the same constituents may be omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

(Overall Configuration)

With reference to the drawings, description is given below of a dispensing method according to one or more embodiments. Note that these embodiments do not limit the invention.

(Robot System 10)

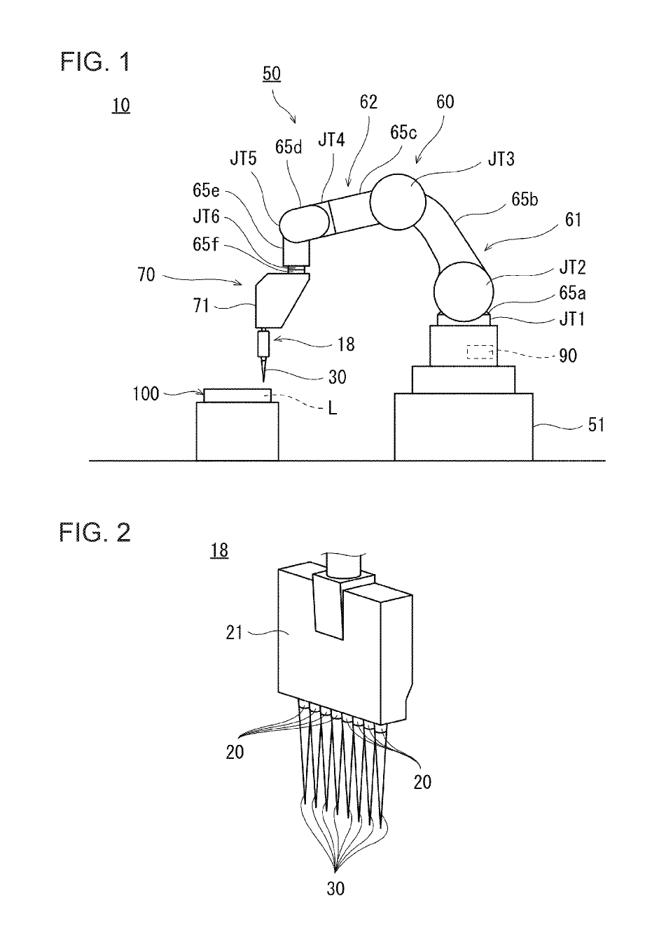

FIG. 1 is a schematic view illustrating an overall configuration of a robot system in which a dispensing method according to one or more embodiments is executed. A robot system 10 according to one or more embodiments is used to automate enzyme-linked immunosorbent assay (ELISA) that has heretofore been manually performed, for example. Here, generally speaking, ELISA is assay to detect and quantify a target antigen and the like contained in a specimen by dispensing reagents and the like to cause antigen-antibody reaction.

As illustrated in FIG. 1, the robot system 10 includes an 8-channel pipette 18 (multichannel pipette), tips 30 attached to channels of the 8-channel pipette 18, respectively, a container 100, a liquid L contained in the container 100, and a robot 50.

(Robot 50)

The robot 50 includes a base 51, a robot arm 60 connected to the base 51, an end effector 70 attached to a leading end of the robot arm 60, and a robot controller 90 that performs operations on pipettes 20 and the tips 30 by controlling the robot arm 60 and the end effector 70.

(Robot Arm 60)

As illustrated in FIG. 1, the robot arm 60 is a multi-joint arm that includes six joints JT1 to JT6 and six links 65a to 65f sequentially connected by the joints JT1 to JT6. The joints JT1 to JT6 of the robot arm 60 each include a motor and an encoder.

A connected body of the links and joints including the first joint JT1, the first link 65a, the second joint JT2, the second link 65b, the third joint JT3, and the third link 65c serves as a first arm section 61 of the robot arm 60. To be more specific, the first joint JT1 connects the base 51 to a base end of the first link 65a in a rotatable manner about an axis extending in a vertical direction. The second joint JT2 connects a leading end of the first link 65a to a base end of the second link 65b in a rotatable manner about an axis extending in a horizontal direction. The third joint JT3 connects a leading end of the second link 65b to a base end of the third link 65c in a rotatable manner about an axis extending in the horizontal direction.

A connected body of the links and joints including the fourth joint JT4, the fourth link 65d, the fifth joint JT5, the fifth link 65e, the sixth joint JT6, and the sixth link 65f serves as a second arm section 62 of the robot arm 60. To be more specific, the fourth joint JT4 connects a leading end of the third link 65c to a base end of the fourth link 65d in a rotatable manner about an axis extending in a longitudinal direction of the third link 65c. The fifth joint JT5 connects a leading end of the fourth link 65d to a base end of the fifth link 65e in a rotatable manner about an axis extending in a direction orthogonal to a longitudinal direction of the fourth link 65d. The sixth joint JT6 connects a leading end of the fifth link 65e to a base end of the sixth link 65f in a torsionally rotatable manner. Then, the end effector 70 is attached to a leading end of the sixth link 65f.

(End Effector 70)

The end effector 70 includes a pipette holder 71 that holds the 8-channel pipette 18 and a pusher (not illustrated) that pushes a plunger of the 8-channel pipette 18 held by the pipette holder 71. The end effector 70 according to one or more embodiments holds the 8-channel pipette 18, thereby holding 8 channels (hereinafter referred to as the “pipettes 20” to avoid complicated description).

(Robot Controller 90)

A specific configuration of the robot controller 90 is not particularly limited. For example, the robot controller 90 may have a configuration realized by a publicly known processor (such as a CPU) operating according to a program stored in a storage unit (memory). The robot controller 90 executes the dispensing method according to one or more embodiments by controlling operations of the robot arm 60 based on pre-stored coordinate information and the like regarding distal ends of the pipettes 20 held by the end effector 70.

(Pipette 20)

FIG. 2 is an external perspective view illustrating the 8-channel pipette and the tips attached thereto used in the dispensing method according to one or more embodiments. As illustrated in FIG. 2, the 8-channel pipette 18 includes the eight pipettes 20, a housing 21 that houses central portions of the eight pipettes 20, and the plunger (not illustrated) provided at an upper end of a member extending upward from a top surface of the housing 21. The 8-channel pipette 18 is configured to aspirate the liquid L such as a reagent into the tips 30 attached to the eight pipettes 20 or to discharge the liquid L aspirated into the tips 30 by having the plunger pushed by the pusher of the end effector 70.

The 8-channel pipette 18 may further include a tip injector (not illustrated) to remove the tips 30 attached to the pipettes 20, an injector button (not illustrated) to activate the tip injector, and an amount setting scale (not illustrated) to set the amount of the liquid to be aspirated into the tips 30.

(Tip 30)

In one or more embodiments, the robot system 10 includes at least eight tips 30 attached to the 8-channel pipette 18. As for each of the tips 30 according to one or more embodiments, at least the point or distal end thereof and its vicinity portion have a hollow conical shape having its diameter increase from the point to the base or proximal end (see FIG. 2 and the like). The tip 30 has an opening formed at its base end, and is attached to the pipette 20 by inserting the distal end portion of the pipette 20 from the opening. Note that the attachment of the tips 30 to the pipettes 20 may be automated in the robot system 10 or may be manually performed in advance.

(Container 100)

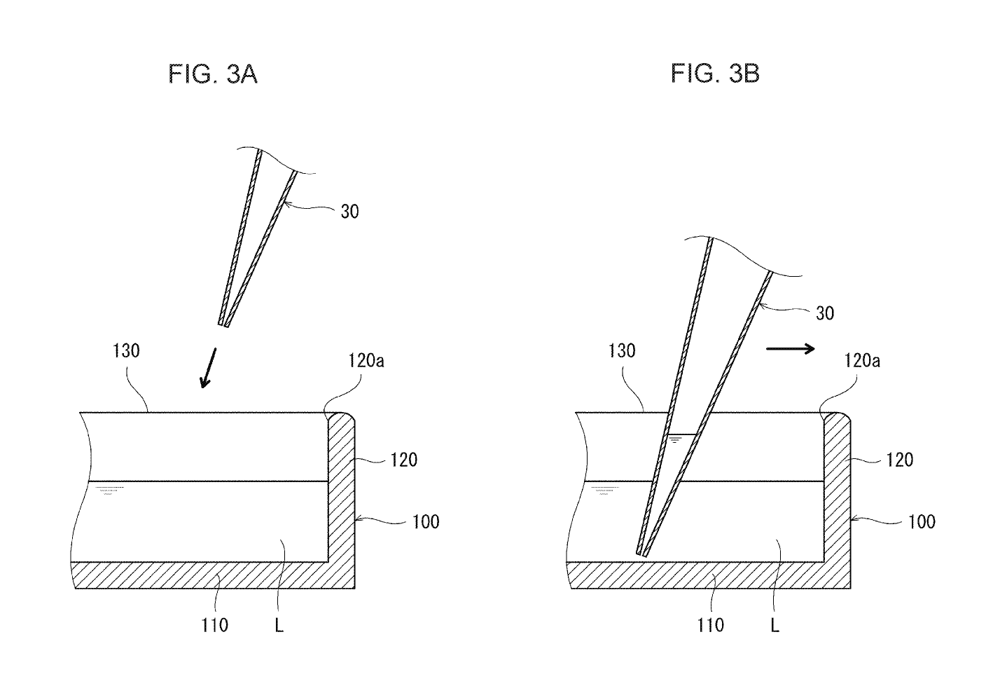

The container 100 according to one or more embodiments is a container (so-called reservoir) widely used for dispensing, which is highly resistant to a reagent and the like. As illustrated in FIG. 3A and the like, the container 100 includes a bottom plate 110, a side plate 120 provided upright from an edge of the bottom plate 110, and an opening 130 formed across the entire top surface. On an inner surface of the side plate 120 (an inside surface of the container 100), a curved portion 120a is provided, which is curved outward when seen from the bottom plate 110 (bottom surface of the container 100). As illustrated in FIG. 3A and the like, as for the curved portion 120a according to one or more embodiments, an outer edge of the upper end portion of the side plate 120 is formed into an arc shape protruding upward, and a lower end of the arc-shaped portion on the inner surface side serves as the curved portion 120a. More specifically, the curved portion 120a is provided near the upper end of the inner surface of the side plate 120 in one or more embodiments.

(Liquid L)

The liquid L according to one or more embodiments is a reagent or the like used in a dispensing step for ELISA executed in the robot system 10.

(Dispensing Method)

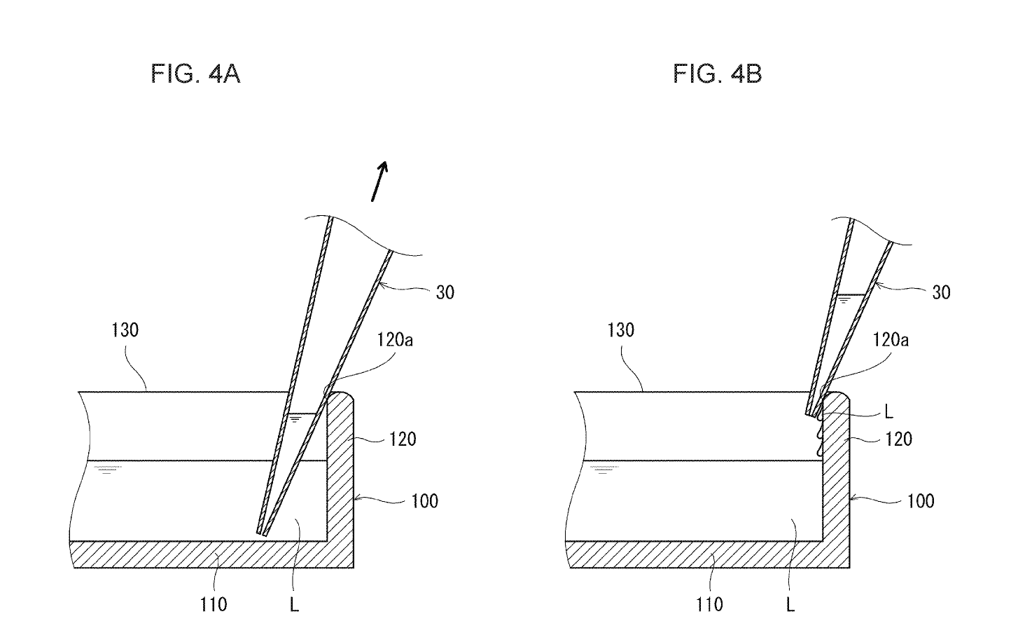

With reference mainly to FIGS. 3A to 4B, description is given of an example of the dispensing method according to one or more embodiments executed in the robot system 10 described above. FIGS. 3A and 3B are schematic views illustrating first and second steps of the dispensing method according to one or more embodiments, FIG. 3A illustrating the first step and FIG. 3B illustrating the second step. FIGS. 4A and 4B are schematic views illustrating third and fourth steps of the dispensing method according to one or more embodiments, FIG. 4A illustrating the third step and FIG. 4B illustrating the fourth step.

(First Step)

First, as illustrated in FIG. 3A, the end effector 70 holds the pipettes 20 and the tips 30 attached thereto. In one or more embodiments, the pipette holder 71 of the end effector 70 holds the 8-channel pipette 18, thereby allowing the end effector 70 to hold the eight pipettes 20 and the tips 30 attached thereto. The first step is thus performed in one or more embodiments.

(Second Step)

Next, the robot arm 60 and the end effector 70 move the pipette 20 and the tip 30 attached thereto in the arrow direction (direction toward the inside of the container 100 along the axis direction of the tip 30) illustrated in FIG. 3A to dip at least the point of the tip 30 attached to the pipette 20 in the liquid L, thereby aspirating the liquid L into the tip 30 as illustrated in FIG. 3B. Note that, in one or more embodiments, the point of the tip 30 attached to the pipette 20 is brought into contact with or close to the inner surface of the bottom plate 110 of the container 100 (the bottom surface of the container 100), and thus at least the point of the tip 30 attached to the pipette 20 is dipped in the liquid L. The second step is thus performed in one or more embodiments.

(Third Step)

The robot arm 60 and the end effector 70 further move the pipette 20 and the tip 30 attached thereto in the arrow direction (horizontal direction) illustrated in FIG. 3B, thereby bringing the outer surface of the tip 30 attached to the pipette 20 into contact with the curved portion 120a (part of the container) formed on the inner surface of the side plate 120 as illustrated in FIG. 4A. Note that, in one or more embodiments, the posture of the tip 30 after the third step is performed (that is, a predetermined angle or the like formed between the axis direction of the tip 30 and the vertical direction) is the same as that when the second step is performed. However, the invention is not limited thereto, but the posture of the tip 30 may be changed as needed. The third step is thus performed in one or more embodiments.

(Fourth Step)

Lastly, the robot arm 60 and the end effector 70 move the pipette 20 and the tip 30 attached thereto in the arrow direction (direction toward the outside of the container 100 along the axis direction of the tip 30) illustrated in FIG. 4A to pull the pipette 20 and the tip 30 attached thereto out of the container 100 through the opening 130 as illustrated in FIG. 4B. In one or more embodiments, the pipette 20 and the tip 30 attached thereto are pulled out of the container 100 through the opening 130 while sliding the outer surface of at least the point of the tip 30 attached to the pipette 20 against the curved portion 120a in the fourth step. The fourth step is thus performed in one or more embodiments.

### Advantageous Effects

In the dispensing method according to one or more embodiments, the liquid L adhering to the outer surface of the tip 30 can be wiped off by pulling the pipette 20 and the tip 30 attached thereto out of the container 100 through the opening 130 after bringing the outer surface of the tip 30 attached to the pipette 20 into contact with the curved portion 120a (part of the container). In other words, the tip 30 is attached to the held pipette 20, and the pipette 20 is moved so as to dip the tip 30 attached to the pipette 20 in the liquid L contained in the container 100, thereby aspirating the liquid L into the tip 30. Then, the pipette 20 is moved in such a manner that the tip 30 holding aspirated liquid L is brought into contact with the container 100 to remove the liquid L adhering to the side surface of the tip 30. Thereafter, the pipette 20 is moved, after the tip 30 is brought into contact with the container 100, to discharge the liquid L from the tip 30. Thus, the liquid L is prevented from adhering to the outer surface of the tip without acquiring a positional relationship between the point of the tip and the liquid surface by using a camera or the like as in the related art method, and keeping the point of the tip at a shallow position from the liquid surface based on the positional relationship, and the like. As a result, the dispensing method according to one or more embodiments is executed in the robot system 10 with a simple device configuration, and also enables accurate dispensing of a desired amount of liquid L.

In one or more embodiments, the liquid L adhering to the outer surface of the tip 30 can be surely wiped off by pulling the pipette 20 and the tip 30 attached thereto out of the container 100 through the opening 130 while sliding the outer surface of at least the point of the tip 30 attached to the pipette 20 against the curved portion 120a (part of the container) in the fourth step.

In one or more embodiments, the point of the tip 30 attached to the pipette 20 is brought into contact with or close to the inner surface of the bottom plate 110 of the container 100 (the bottom surface of the container 100) in the second step. Thus, at least the point of the tip 30 attached to the pipette 20 can be surely dipped in the liquid L without recognizing a height position of the liquid surface by complicated image processing or the like, for example. Moreover, even when the amount of the liquid L is decreased and the height position of the liquid surface comes close to the inner surface of the bottom plate 110, failure to dip the tip 30 in the liquid L does not occur. Accordingly, the liquid L can be used up to the last drop.

In one or more embodiments, the point of the tip 30 attached to the pipette 20 is brought into contact with or close to the bottom plate 110 of the container 100 in a state where the axis direction of the tip 30 attached to the pipette 20 is tilted by a predetermined angle with respect to the vertical direction, as illustrated in FIG. 3B, in the second step. Thus, the opening in the point of the tip 30 can be prevented from being crushed or closed by the point of the tip 30 being pushed against the bottom plate 110, compared with the case where the point of the tip 30 is brought into contact with or close to the bottom plate 110 of the container 100 in a state where the axis direction of the tip 30 extends along the vertical direction, for example.

(Modification)

From the above description, many variations and other embodiments of the disclosure will be apparent to one skilled in the art. Therefore, the above description is to be construed as illustrative only, and is provided to teach one skilled in the art the best mode of implementing the invention. Details of the structures and/or functions can be substantially changed without departing from the spirit of the invention.

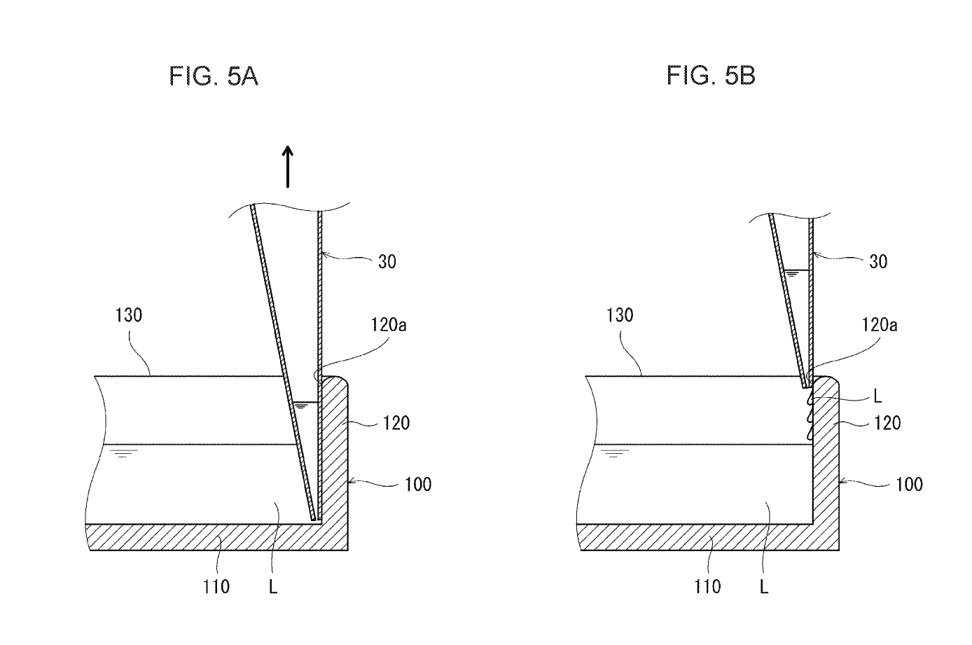

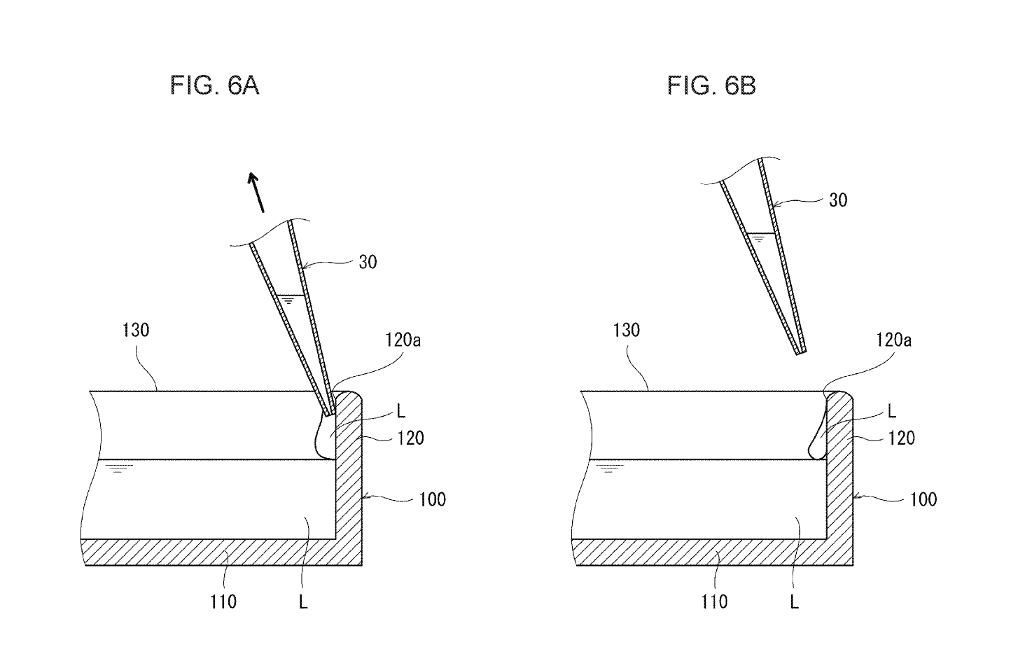

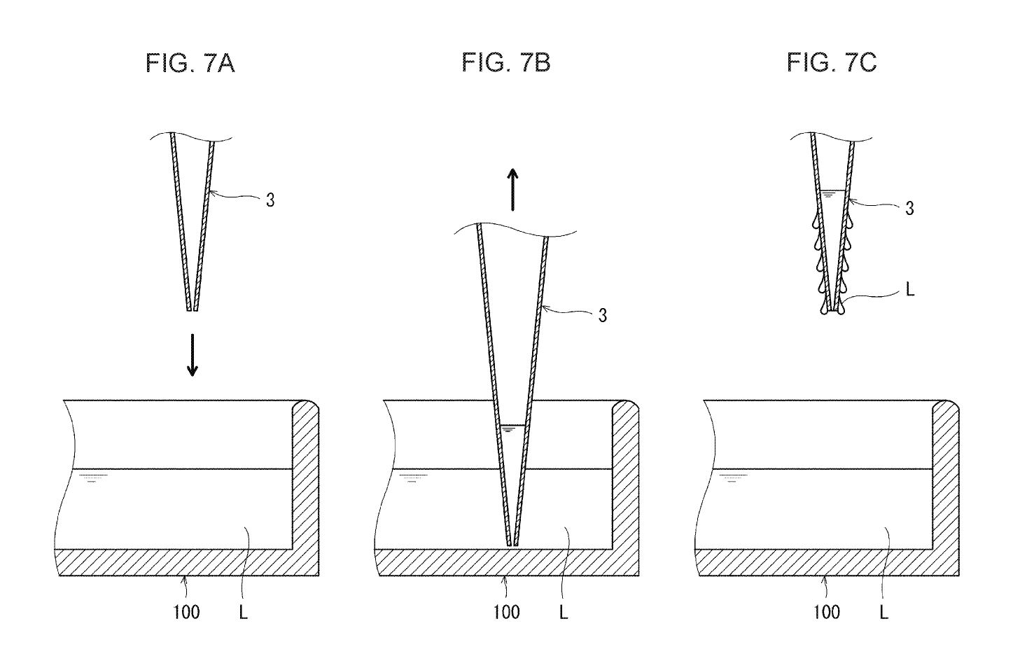

In the above embodiments, the description is given of the case where the outer surface of the tip 30 attached to the pipette 20 is brought into contact with the curved portion 120a formed on the inner surface of the side plate 120 (the inside surface of the container 100) in the third step and the case where the tip 30 attached to the pipette 20 is pulled out of the container 100 through the opening 130 while sliding the outer surface of at least the point of the tip 30 attached to the pipette 20 against the curved portion 120a in the fourth step. However, the invention is not limited thereto. For example, a first modification illustrated in FIGS. 5A and 5B, a second modification illustrated in FIGS. 6A and 6B, and the like are conceivable.

FIGS. 5A and 5B are schematic views illustrating third and fourth steps of a dispensing method according to a first modification, FIG. 5A illustrating the third step and FIG. 5B illustrating the fourth step.

As illustrated in FIG. 5A, in the third step according to a first modification, the outer surface of the tip 30 attached to the pipette 20 may be brought into contact with a portion of the inner surface of the side plate 120 (the inside surface of the container 100), the portion extending in a height direction of the inner surface of the side plate 120 (the inside surface of the container 100). To be more specific, the outer surface of the tip 30 may be brought into contact with approximately the entire area in the height direction of the inner surface of the side plate 120 (the inside surface of the container 100), for example. Then, the pipette 20 and the tip 30 attached thereto may be moved in the arrow direction (direction toward the outside of the container 100 along the axis direction of the tip 30) illustrated in FIG. 5A and pulled out of the container 100 through the opening 130 while sliding the outer surface of at least the point of the tip 30 attached to the pipette 20 against the portion extending in the height direction of the inner surface of the side plate 120 in the fourth step.

FIGS. 6A and 6B are schematic views illustrating third and fourth steps of a dispensing method according to a second modification, FIG. 6A illustrating the third step and FIG. 6B illustrating the fourth step.

In a second modification, the tip 30 attached to the pipette 20 may be pulled out of the container 100 through the opening 130 (without sliding the outer surface of the tip 30 attached to the pipette 20 against a part of the container 100), after bringing the outer surface of the tip 30 attached to the pipette 20 into contact with the inner surface of the side plate 120 (the inside surface of the container 100) in the third step according to a second modification as illustrated in FIG. 6A. Even through such procedure, the liquid L adhering to the outer surface of the tip 30 can be wiped off by the surface tension of the inside surface of the container 100 as illustrated in FIGS. 6A and 6B.

In the above embodiments, the description is given of the case where the outer edge of the upper end portion of the side plate 120 is formed into an arc shape protruding upward, and the lower end of the arc-shaped portion on the inner surface side serves as the curved portion 120a. However, the invention is not limited thereto. For example, when the side plate 120 has a simple flat plate shape and the outer edge of the upper end portion of the side plate 120 has a square shape, the inner-side upper end of the square shape portion (that is, the inner-side corner of the square shape portion or the edge of the opening 130 of the container 100) may serve as the curved portion 120a. In such a case, the edge of the opening 130 of the container 100 and the inner surface of the side plate 120 are both included as a part of the container in the third and fourth steps.

In the above embodiments, the description is given of the case where the opening 130 is formed across the entire top surface of the container 100. However, the invention is not limited thereto. More specifically, the container 100 may further include a top plate, and an opening may be formed by drilling a through-hole in the top plate. In such a case, an edge of the opening formed in the top plate is included as a part of the container in the third and fourth steps.

In the above embodiments, the description is given of the case where the outer surface of the tip 30 is brought into contact with a part of the container, which is the curved portion 120a of the inner surface of the side plate 120 (the inside surface of the container 100) or the portion extending in the height direction of the inner surface of the side plate 120 (the inside surface of the container 100). In this event, the outer surface of the tip 30 may be pushed against a part of the container 100 to the extent that the tip 30 slightly bends, for example. Thus, the outer surface of the tip 30 can be surely brought into contact with a part of the container 100. In this way, the outer surfaces of all the tips 30 can be surely brought into contact with a part of the container 100 even in case of misalignment of the tips 30 attached to the eight channels when the dispensing method according to disclosure is performed using a multi-channel pipette such as the 8-channel pipette 18 in the above embodiments.

In the above embodiments, the description is given of the case where the axis direction of the tip 30 attached to the pipette 20 is tilted by a predetermined angle with respect to the vertical direction so as to approach the side plate 120 from the point to the base, as illustrated in FIG. 3A, in the first step of making the end effector 70 hold the pipette 20 and the tip 30 attached thereto. However, the invention is not limited thereto. More specifically, in the first step, the axis direction of the tip 30 attached to the pipette 20 may be tilted by a predetermined angle with respect to the vertical direction so as to get away from the side plate 120 from the point to the base, or the axis direction of the tip 30 attached to the pipette 20 may extend along the vertical direction.

In the above embodiments, the description is given of the case where the tip 30 attached to the pipette 20 is moved into the container 100 along the axis direction of the tip 30 after the axis direction of the tip 30 attached to the pipette 20 is tilted by a predetermined angle with respect to the vertical direction so as to approach the side plate 120 from the point to the base, as illustrated in FIGS. 3A and 3B, in the second step of aspirating the liquid L into the tip 30 by dipping at least the point of the tip 30 attached to the pipette 20 in the liquid L. However, the invention is not limited thereto. More specifically, the tip 30 attached to the pipette 20 may be moved into the container 100 along the axis direction of the tip 30 after the axis direction of the tip 30 attached to the pipette 20 is tilted by a predetermined angle with respect to the vertical direction so as to get away from the side plate 120 from the point to the base. Alternatively, the tip 30 attached to the pipette 20 may be moved into the container 100 along the axis direction of the tip 30 after the axis direction of the tip 30 attached to the pipette 20 is set so as to extend along the vertical direction. Alternatively, the tip 30 attached to the pipette 20 may be moved into the container 100 in a direction that does not follow the axis direction of the tip 30.

In the above embodiments, FIGS. 3A to 4B, and the like illustrate the case where the bottom plate 110 of the container 100 is placed along the horizontal plane. However, the invention is not limited thereto. For example, the bottom plate 110 may be placed on an inclined plane that is tilted downward toward the side plate 120. Thus, the liquid L is accumulated in the vicinity of the connection between the bottom plate 110 and the side plate 120. Therefore, even when the amount of the liquid L is reduced, the pipette 20 and the tip 30 attached thereto can easily aspirate the liquid L. Accordingly, the liquid L in the container 100 can be used up to the last drop. Note that, in such a case, it may be preferable that the axis direction of the tip 30 extend along the vertical direction or be tilted by a predetermined angle with respect to the vertical direction so as to get away from the side plate 120 from the point to the base. Thus, the point of the tip 30 can be moved to the connection between the bottom plate 110 and the side plate 120 without getting hindered by the side plate 120. As a result, the advantageous effects described above can be surely achieved.

In the above embodiments, the description is given of the case where the end effector 70 holds the 8-channel pipette 18. However, the invention is not limited thereto. More specifically, the end effector 70 may hold a single-channel pipette (or one pipette 20) or may hold a multi-channel pipette other than the 8-channel pipette (that is, a multi-channel pipette with two to seven channels or a multi-channel pipette with nine or more channels). The robot system 10 may include the tip or tips 30 corresponding to the one pipette 20 or the number of channels (that is, pipettes 20) included in the multi-channel pipette.

In the above embodiments, the description is given of the case where the robot arm 60 is the multi-joint arm with a six-axis structure. However, the invention is not limited thereto. More specifically, the robot arm 60 may be a multi-joint arm with at least one axis or may be a multi-joint arm with a seven-axis structure. Alternatively, the robot arm 60 may be an arm with a linear-motion axis.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A dispensing method executed in a robot system, wherein the robot system comprises: a pipette; a tip attached to the pipette; a container including a bottom surface, an inside surface, and an opening; a liquid contained in the container; and a robot including a robot arm, an end effector attached to a leading end of the robot arm, and a robot controller that controls the robot arm and the end effector to perform operations on the pipette and the tip, the method comprising:
making the end effector hold the pipette and the tip attached to the pipette;
dipping at least a point of the tip attached to the pipette in the liquid and aspirating the liquid into the tip;
bringing an outer surface of the tip attached to the pipette into contact with a part of the container, wherein the part of the container is at least one of an edge of the opening and the inside surface; and
pulling the pipette and the tip attached to the pipette out of the container through the opening.

2. The dispensing method according to claim 1, wherein
the pulling the pipette and the tip attached to the pipette out of the container through the opening comprises pulling the pipette and the tip attached to the pipette out of the container through the opening while sliding the outer surface of at least the point of the tip attached to the pipette against the part of the container.

3. The dispensing method according to claim 1, wherein
the opening is formed across an entire top surface of the container, and the part of the container is a curved portion positioned at an upper end of the inside surface or in a vicinity of the upper end of the inside surface.

4. The dispensing method according to claim 2, wherein
the opening is formed across an entire top surface of the container, and the part of the container is a curved portion positioned at an upper end of the inside surface or in a vicinity of the upper end of the inside surface.

5. The dispensing method according to claim 1, wherein
the opening is formed across an entire top surface of the container, and the part of the container is a portion of the inside surface, the portion extending in a height direction of the inside surface.

6. The dispensing method according to claim 2, wherein
the opening is formed across an entire top surface of the container, and the part of the container is a portion of the inside surface, the portion extending in a height direction of the inside surface.

7. The dispensing method according to claim 1, wherein
the dipping at least the point of the tip attached to the pipette in the liquid and aspirating the liquid into the tip comprises dipping at least the point of the tip attached to the pipette in the liquid by bringing the point of the tip attached to the pipette into contact with or close to the bottom surface of the container.

8. A dispensing method to be executed in a robot system, comprising:
attaching a tip to a held pipette;
moving the pipette so as to dip the tip in a liquid contained in a container, and aspirating the liquid into the tip;
moving the pipette so as to bring the tip holding the aspirated liquid into contact with the container, thereby removing the liquid adhering to a side surface of the tip; and
moving the pipette after bringing the tip into contact with the container, and discharging the liquid from the tip.
